(19) United States
(12) Patent Application Publication
(10) Pub. No.: US 2003/0070510 A1
(43) Pub. Date: Apr. 17, 2003

(54) Semi-automatic jar opener

(76) Inventor: Donald Tremblav, Quebec (CA)

Correspondence Address: Mr. Donald Tremblav, 835 . du Coteau. Ste-Fov., Quebec, G1X 2P1, CA

(21) Appl. No.: 09/974,513

(22) Filed: Oct. 11, 2001

(51) Int. Cl. B67B 7/00

(52) U.S. Cl. 81/3.2

(57) ABSTRACT

The present disclosure is a semi-automatic jar opener made up of a lower part provided with an electric motor allowing to squeeze the jar in accordance with the desired size and to make turn it, and of an upper part allowing to adjust manually the height of jar, and when the plate from the lower part turns, the jaws squeeze the lid for unscrew the jar.

### BACKGROUND OF THE INVENTION

1. Field of the Invention:

The present invention relates to a semi-automatic jar opener adapted for unscrew the lid from any sizes of jars coming from food stores or groceries without physical strenght.

2. Description of the related art:

A search of prior art records has unveiled the following Canadian patent:

1. No. 432070 issued in 1945 to Gaulin.

The patent to Gaulin is probably the most relevant.

As is known, many persons use the bottle and jar opener from Gaulin. As can be seen, the problem encountered is that the jar opener is not semi-automatic, and is not conceived for the elders having little or no physical strength and for the handicapped persons, because they must to take the jar or the bottle in the left hand, take the opener in the right hand, place it on top of the cover, and make a twist of the wrist in anticlockwise direction for remove the cover from any bottle or jar.

To overcome the above-mentioned problem, the applicant has developped a semi-automatic jar opener used for unscrew the lid from any sizes of jars without physical strenght.

### SUMMARY OF THE INVENTION

The gist of the invention is therefore to provide a semi-automatic jar opener allowing to handicapped persons, elders and the other persons to unscrew the lid from any sizes of jars coming from food stores or groceries without physical strenght.

The present invention shows a semi-automatic jar opener made up of a lower part allowing to squeeze the jar in accordance with the desired size and to make turn it, and of an upper part allowing to adjust manually the height of jar, and when the plate from the lower part turns, the jaws squeeze the lid for unscrew the jar.

Advantages of the Invention:

No physical strenght required from the user;

Can be operated only with one hand;

Easy to operate; and

Does not require to be fixed at any surface.

### BRIEF DESCRIPTION OF THE SEVERAL VIEWS OF THE DRAWING(S)

FIG. 1 is a front perspective view of the semi-automatic jar opener showing the jar installed.

FIG. 2 is a front elevational view of the semi-automatic jar opener showing the jar installed.

FIG. 3 is a perspective view showing the lower part from the semi-automatic jar opener.

FIG. 4 is a perspective view showing the upper part from the semi-automatic jar opener.

FIG. 5 is a cut view of the lower mechanism of the semi-automatic jar opener.

FIG. 6 is a cut view of the upper mechanism of the semi-automatic jar opener.

### DETAILED DESCRIPTION OF THE INVENTION

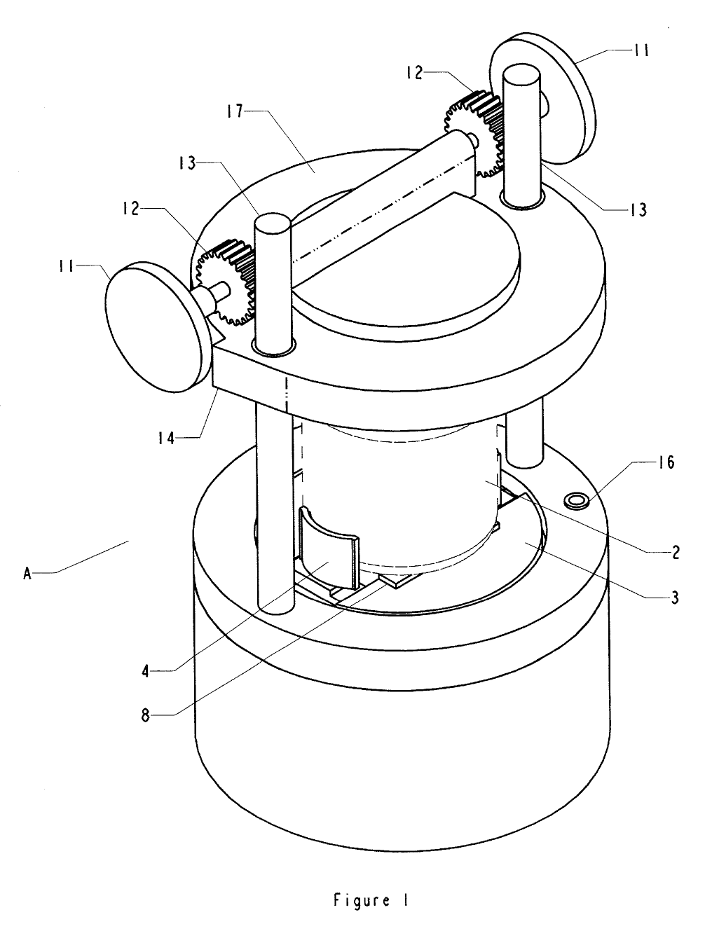

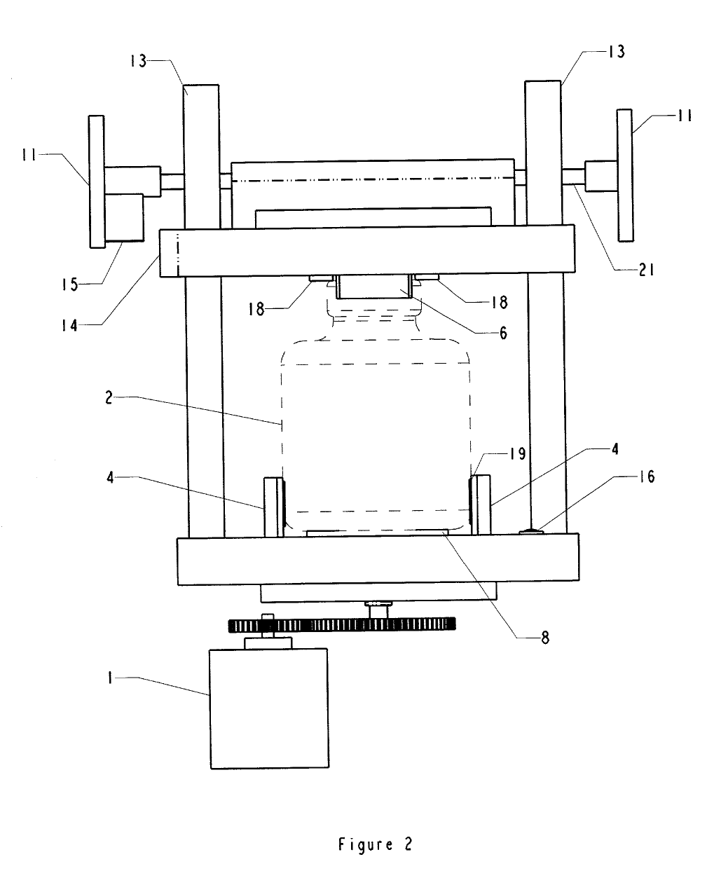

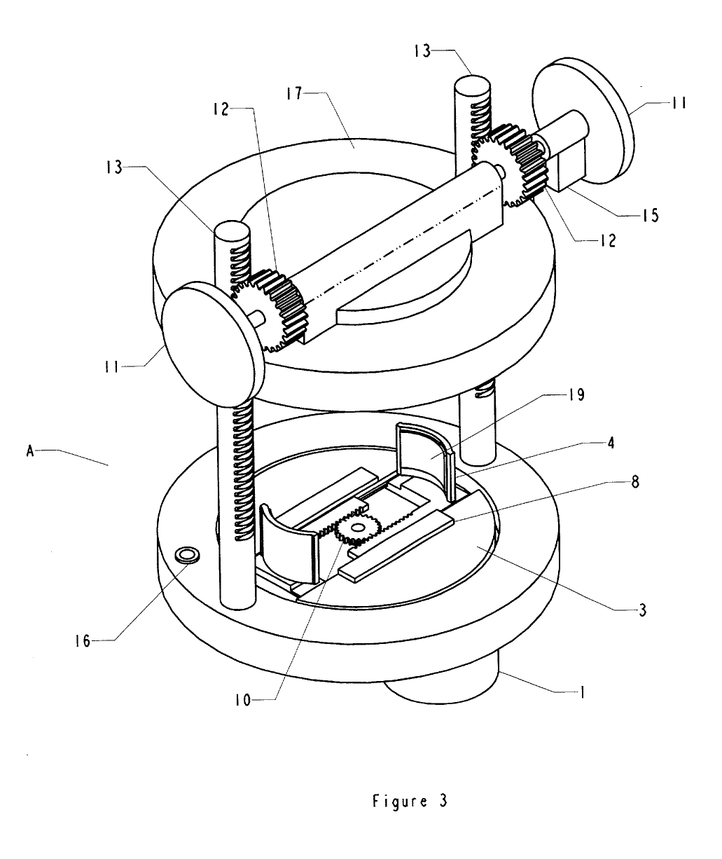

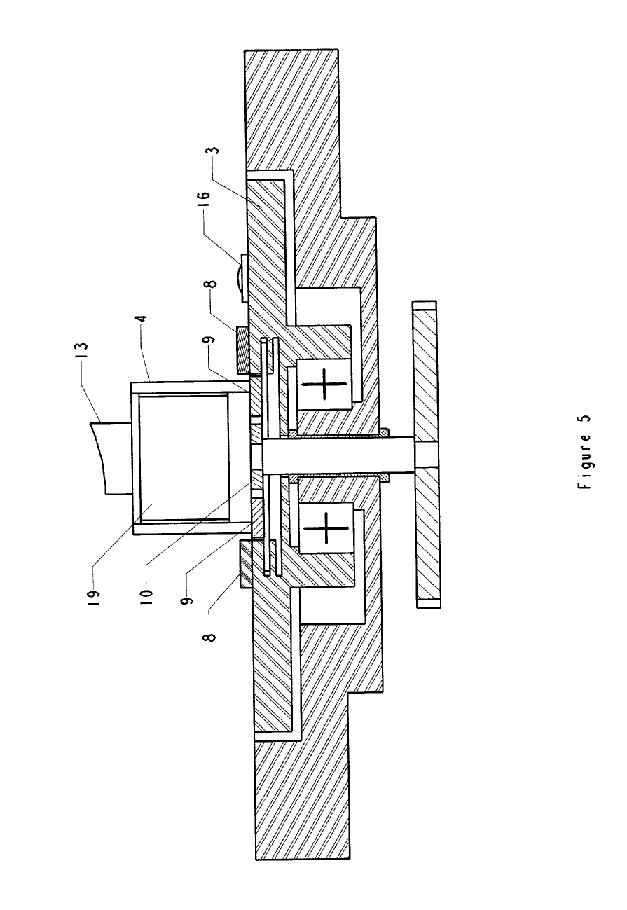

As shown in FIGS. 1, 2, 3 and 5, a semi-automatic jar opener (A) comprising a lower part provided with an electric motor (1) made up of a run button (16) allowing to activate the gear rack (10), the jaws (4) provided with non-skid rubber strips (19) for squeeze the jar (2), and makes turn the plate (3) and the jar (2). When the jar (2) turns, the friction rubber strips (8) prevent the sliding jar (2), and the electric motor (1) stops to operate when the jar (2) is unscrewed.

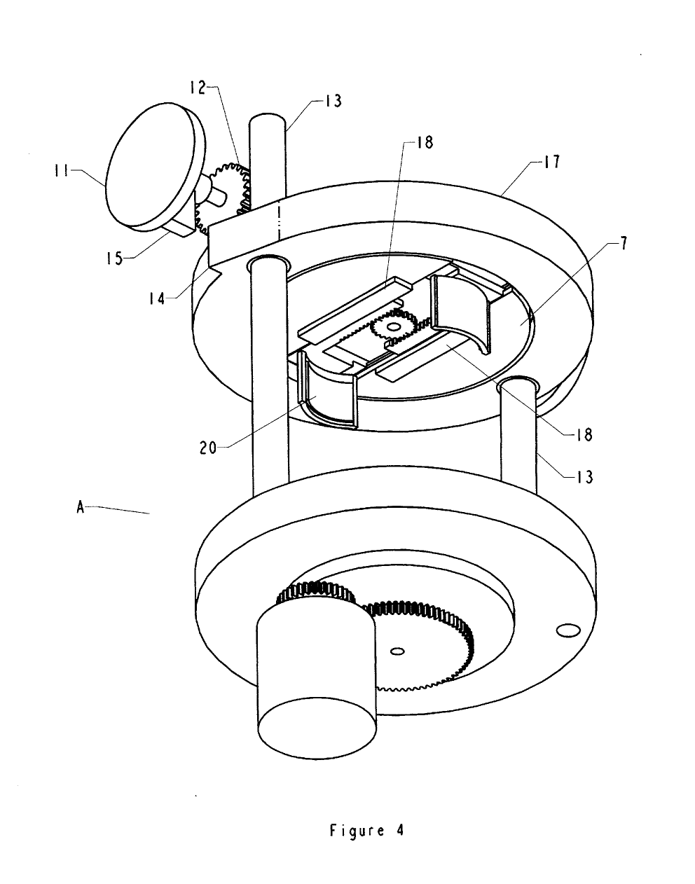

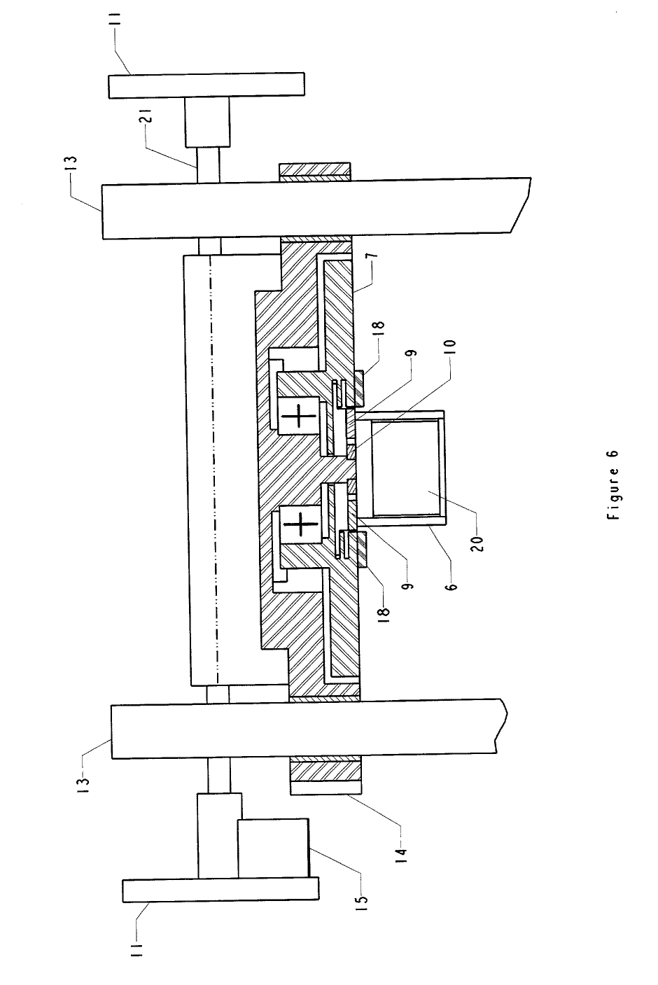

As shown in FIGS. 1, 2, 4 and 6, a semi-automatic jar opener (A) made up of an upper part joined to the lower part by the serrated vertical post (13) allowing to adjust manually the height of jar (2) by means of a shaft (21), the gears (12) and knobs (11). In pulling on the knob (11) provided with a means locking (15), the gears (12) and the serrated vertical post (13) are unblocked for adjust manually the height of jar (2). The jaws (6) provided with non-skid rubber strips (20) maintain firmly the lid in position, and the friction rubber strips (18) prevent the sliding lid.

The extension (14) of the base (17) from the upper part allows to means locking (15) to block the knob (11) when the jar (2) is removed from the semi-automatic jar opener (A). When the jar (2) and the plate (7) turn, the jaws (6) close firmly on the lid until it reaches the required torsion for unscrew the jar.

I claim:

1. A semi-automatic jar opener having two parts, adapted for unscrew the lid from any sizes jars, said jar opener comprising:
(a) a lower part provided with an electric motor made up of a run button allowing to activate the gear rack, the jaws provided with non-skid rubber strips for squeeze the jar, and makes turn the plate and the jar. When the jar turns, the friction rubber strips prevent the sliding jar, and the electric motor stops to operate when the jar is unscrewed; and
(b) an upper part joined to the lower part by the serrated vertical post allow to adjust manually the height of jar by means of a shaft, the gears and knobs. In pulling on the knob provided with a means locking, the gears and the serrated vertical post are unblocked for adjust manually the height of jar. The jaws provided with non-skid rubber strips maintain firmly the lid in position, and the friction rubber strips prevent the sliding lid. The extension of the base from the upper part allows to means locking to block the knob when the jar is removed from the semi-automatic jar opener (A). When the jar and the plate turn, the jaws close firmly on the lid until it reaches the required torsion for unscrew the jar.
